(19) United States
(12) Patent Application Publication
(10) Pub. No.: US 2006/0076870 A1
(43) Pub. Date: Apr. 13, 2006

(54) Discharge lamp, discharge lamp socket, discharge lamp device, and discharge lamp lighting device

(75) Inventors: Kazuya Kurokawa, Hyogo (JP); Masanori Komura, Osaka (JP); Shiki Nakayama, Osaka (JP); Shunsuke Kakisaka, Osaka (JP)

Correspondence Address: FRISHAUF, HOLTZ, GOODMAN & CHICK, PC, 220 Fifth Avenue, 16TH Floor, NEW YORK, NY, 10001-7708, US

(73) Assignees: Ushio Denki Kabushiki Kaisha, Tokyo (JP); Matsushita Electric Industrial Co., Ltd., Osaka (JP)

(21) Appl. No.: 10/535,908

(22) PCT Filed: Feb. 19, 2004
(86) PCT No.: PCT/JP04/01916

§ 371 Date: May 20, 2005

(30) Foreign Application Priority Data
Feb. 26, 2003 (JP) 2003-049764

(51) Int. Cl. H01J 5/48; H01J 5/50

(52) U.S. Cl. 313/318.01; 313/318.12

(57) ABSTRACT

A discharge lamp is constructed by attaching a base to an outer tube, the base has a spiral feed member and a dotted feed member, and the shortest creeping clearance distance between the spiral feed member and the dotted feed member is defined to at least 6.0 mm. A socket for discharge lamp is constructed by providing a spiral receiving member and a contact piece in an insulating socket body, and the shortest clearance distance between the spiral receiving member and the contact piece is defined to at least 5.0 mm. A socket for discharge lamp is constructed by providing a spiral receiving member and a contact piece in an insulating socket body, and the shortest clearance distance between a socket reference line and the contact piece is defined to at least 19.6 mm.

### TECHNICAL FIELD

The present invention relates to a discharge lamp, a socket for discharge lamp, a discharge lamp device and a discharge lamp lighting device.

### BACKGROUND ART

Incandescent halogen lamps have heretofore been widely used as lamps for light source for various lighting systems. In recent years, however, discharge lamps emitting light of high luminance or high color temperature have come to be suitably used.

On the other hand, a lamp for light source in a lighting system is generally used by fitting a base part of the lamp for light source into a proper socket provided in the lighting system. In particular, a lamp for light source provided with a base part having dimensions according to the conditions of the E11 base (hereinafter referred to as “E11 base” merely) prescribed in Japanese Industrial Standards is generally used by its corresponding socket.

Under the foregoing circumstances, discharge lamps equipped with a base part according to the conditions of the E11 base and their corresponding sockets for discharge lamps have been developed and proposed (for example, Japanese Patent Application Laid-Open No. 2001-167737).

However, a lamp having a base part of dimensions according to the same standards, the E11 base, can be physically permitted to be received into the same socket even when the lamp is either a discharge lamp or an incandescent halogen lamp.

When an incandescent halogen lamp is installed into a socket for discharge lamp by mistake, however, high voltage necessary for lighting a discharge lamp is applied to the incandescent halogen lamp through the socket for discharge lamp, whereby a bulb of the incandescent halogen lamp may possibly be burst. Accordingly, there is a problem that an extremely dangerous situation occurs.

### DISCLOSURE OF THE INVENTION

[Problems to be Solved by the Invention]

The present invention has been made on the basis of the foregoing circumstances and has as its object the provision of a socket for discharge lamp, which has high safety by itself and retains the high safety even if an incandescent halogen lamp is installed into the socket by mistake, a discharge lamp, a discharge lamp device and a discharge lamp lighting device.

[Means for Solving the Problems]

According to the present invention, there is provided a discharge lamp constructed by housing an arc tube having a pair of discharge electrodes in the interior of an outer tube having a sealed part at a one-end thereof and attaching a base to the one-end of the outer tube, and lighted by ignition voltage of 2.0 to 3.5 KVrms or pulse voltage of 3 to 5 KV in terms of maximum pulse height, and

the base has an insulating base body having a feed member-supporting part and a projected part protruding and extending from a distal end of the feed member-supporting part, a spiral feed member provided on an outer periphery of the feed member-supporting part, electrically connected to one of the pair of the discharge electrodes and having a width of 10.4 to 11.0 mm, and a dotted feed member provided on a tip end of the projected part and electrically connected to the other of the pair of the discharge electrodes,

wherein, in the base, the shortest creeping clearance distance between the spiral feed member and the dotted feed member along an outer surface of the projected part of the base body is defined to at least 6.0 mm.

According to the present invention, there is provided a socket for discharge lamp, into which a base part provided on a discharge lamp lighted by ignition voltage of 2.0 to 3.5 KVrms or pulse voltage of 3 to 5 KV in terms of maximum pulse height is received, and

a cylindrical and spiral receiving member, into which a spiral feed member in the base part of the discharge lamp is screwed, and a contact piece, with which a dotted feed member in the base part is brought into contact, are provided in an insulating socket body,

wherein the shortest clearance distance between the spiral receiving member and the contact piece is defined to at least 5.0 mm.

According to the present invention, there is also provided a socket for discharge lamp, into which a base part provided on a discharge lamp lighted by ignition voltage of 2.0 to 3.5 KVrms or pulse voltage of 3 to 5 KV in terms of maximum pulse height is received, and

a cylindrical and spiral receiving member, into which a spiral feed member in the base part of the discharge lamp is screwed, and a contact piece, with which a dotted feed member in the base part is brought into contact, are provided in an insulating socket body,

wherein, when a base part satisfying the conditions of the E11 base prescribed in Japanese Industrial Standards is received, the shortest clearance distance between a socket reference line conforming to a base reference line of a base making up the base part and the contact piece is defined to at least 19.6 mm.

According to the present invention, there is provided a discharge lamp device comprising the discharge lamp described above and a socket for discharge lamp, into which the base part provided on the discharge lamp is received, and

the socket for discharge lamp is constructed by providing a cylindrical and spiral receiving member, into which a spiral feed member in the base part of the discharge lamp is screwed, and a contact piece, with which a dotted feed member in the base part is brought into contact, in an insulating socket body,

wherein, in the socket for discharge lamp, the shortest clearance distance between the spiral receiving member and the contact piece is defined to at least 5.0 mm, and when a base part satisfying the conditions of the E11 base prescribed in Japanese Industrial Standards is received, the shortest clearance distance between a socket reference line conforming to a base reference line of a base making up the base part and the contact piece is defined to at least 19.6 mm.

According to the present invention, there is further provided a discharge lamp lighting device comprising a lighting circuit for lighting the discharge lamp described above at a lighting frequency of 50 Hz to 100 kHz.

According to the discharge lamp of the present invention, in the base making up the base part, the shortest creeping clearance distance between the spiral feed member and the dotted feed member along the outer surface of the projected part of the base body is defined to at least 6.0 mm, whereby high insulating property is achieved between the spiral feed member and the dotted feed member, so that discharge between them is surely prevented, and thus high safety is obtained.

According to the socket for discharge lamp of the present invention, the shortest clearance distance between the spiral receiving member, into which the spiral feed member in the base part of the discharge lamp to be installed is screwed, and the contact piece, with which the dotted feed member in the base part is brought into contact, is defined to at least 5.0 mm, whereby discharge between them is surely prevented, and thus high safety is obtained.

The socket for discharge lamp is so constructed, that when a base part satisfying the conditions of the E11 base is received into the socket for discharge lamp, the shortest clearance distance between a socket reference line conforming to a base reference line of a base making up the base part and the contact piece is defined to at least 19.6 mm, whereby even when an incandescent halogen lamp having a base part according to the conditions of the E11 base is installed by mistake, a dotted feed member of the base part of the incandescent halogen lamp and the contact piece of the socket for discharge lamp are in a state separated from each other at a sufficient distance, so that high voltage for lighting a discharge lamp is surely prevented from being applied to the incandescent halogen lamp, and occurance of discharge between the dotted feed member and the contact piece is also surely prevented.

According to the discharge lamp device of the present invention, the discharge lamp device is constructed by the above-described discharge lamp and socket for discharge lamp, whereby the same operations and effects as described above can be surely achieved.

### BRIEF DESCRIPTION OF THE DRAWINGS

FIG. 1 is a cross-sectional view illustrating the construction of an exemplary discharge lamp according to the present invention.

FIG. 2 is a cross-sectional view illustrating the construction of an exemplary socket for discharge lamp ccording to the present invention.

FIG. 3 illustrates the construction of a discharge lamp device according to the present invention, which is composed of the discharge lamp shown in FIG. 1 and the socket for discharge lamp shown in FIG. 2.

FIG. 4 is a cross-sectional view illustrating a state that a base part satisfying the standards related to an E11 base prescribed in Japanese Industrial Standards has been fitted in the socket for discharge lamp shown in FIG. 2.

FIG. 5 is a partially cross-sectional view illustrating the construction of a modified example of the discharge lamp according to the present invention.

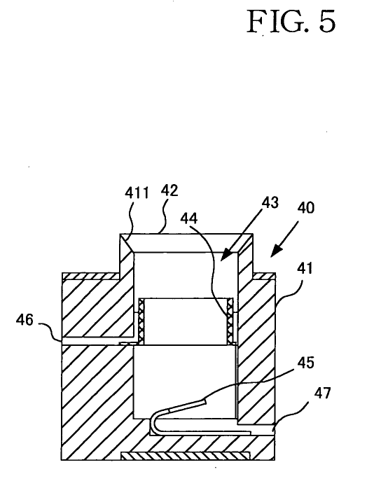

### DESCRIPTION OF CHARACTERS

10 Discharge lamp,
11 Outer tube,
111 Exhaust tube residue,
12 Arc tube,
13 Sealed part,
131, 132 Metal foils,
141, 142 One and the other lead rods,
151, 152 One and the other internal lead rods for feed,
161, 162 External lead rods,
17 Trigger electrode,
20 Base,
21 Outer tube-holding part,
22 Feed member-supporting part,
23 Projected part,
24 Spiral feed member,
25 Dotted feed member,
261, 262 One and the other lead wires,
27 Contact part,
28 Through-hole,
40 Socket for discharge lamp,
41 Socket body,
411 End surface,
42 Cylindrical edge portion,
43 Receiving space,
44 Spiral receiving member,
45 Contact piece,
46, 47 One and the other guiding parts for external feed wires,
50 Base,
54 Spiral feed member,
55 Dotted feed member.

### BEST MODE FOR CARRYING OUT THE INVENTION

The embodiments of the present invention will hereinafter be described in detail.

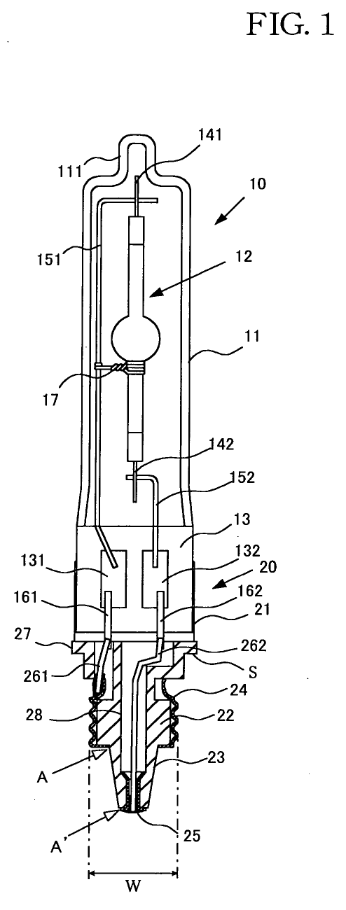

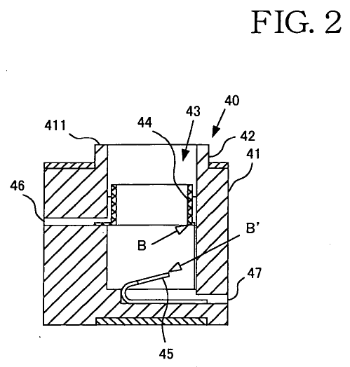

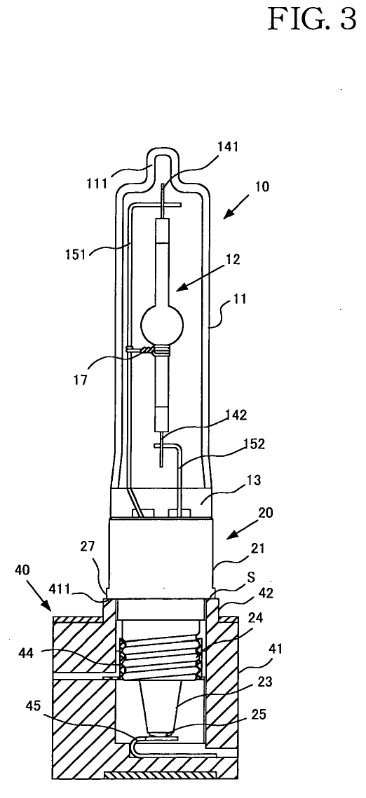

FIG. 1 is a cross-sectional view illustrating the construction of an exemplary discharge lamp according to the present invention, FIG. 2 is a cross-sectional view illustrating the construction of an exemplary socket for discharge lamp according to the present invention, and FIG. 3 is a cross-sectional view illustrating the construction of a discharge lamp device according to the present invention, which is composed of the discharge lamp shown in FIG. 1 and the socket for discharge lamp shown in FIG. 2.

In the embodiments illustrated, the discharge lamp 10 is the so-called one end-sealed type discharge lamp equipped with a base and is constructed by providing a base part formed of a base 20 on one end of an outer tube 11, in the interior of which an arc tube 12 has been housed. In this discharge lamp 10, the outer tube 11 is composed of, for example, silica glass, a flat sealed part 13 is formed at its one end by sealing with pressure, and an exhaust tube residue 111 is provided at the other end thereof.

The arc tube 12 is equipped with a pair of discharge electrodes (not illustrated), and, for example, a metal halide, rare gas, mercury or the like is filled in a discharge space in the interior thereof. Tip end of one internal lead rod 151 for feed and the other internal lead rod 152 for feed, which respectively extend from metal foils 131 and 132 laid in the sealed part 13 of the outer tube 11 to the interior of the outer tube 11, are connected to one lead rod 141 and the other lead rod 142 extending from the pair of the discharge electrodes, respectively, whereby the arc tube is supported within the outer tube 11. External lead rods 161 and 162 extending outward from the sealed part 13 are respectively connected to the metal foils 131 and 132 in the sealed part 13 of the outer tube 11. The interior of the outer tube 11 is kept in, for example, a vacuum state. Reference numeral 17 indicates a trigger electrode provided on the arc tube 12.

The discharge lamp 10 described above is lighted by ignition voltage of 2.0 to 3.5 KVrms or lighted by pulse voltage of 3 to 5 KV in terms of maximum pulse height.

The base 20 is formed by providing feed members on a base body composed of, for example, an alumina-silica-based insulating ceramic. A base part of the discharged lamp 10 is formed by this base 20.

The base body is formed by an outer tube-holding part 21 on top portion, a feed member-supporting part 22 following the outer tube-holding part 21 and a conical projected part 23 protruding so as to greatly extend downward in an axial direction from the feed member-supporting part 22. In the outer tube-holding part 21, a grooved lamp-receiving portion (not illustrated) is formed so as to open to an upper surface thereof.

On the feed member-supporting part 22 of this base body, a cylindrical and spiral feed member 24 made of a metal is provided and fixed to an outer peripheral surface thereof, and a dotted feed member 25 made of a metal is provided at a position of a tip end surface of the projected part 23, at which a through-hole 28 extending through in the axial direction of the base body opens, so as to close the opening of the through-hole 28. In the spiral feed member 24 shown in FIG. 1, its width W, which is a maximum clearance distance in a radial direction between a crest part of a rise and another crest part at a position opposed to the first-mentioned crest in the radial direction, is 10.4 to 11.0 mm. Namely, the value of the width W includes a range of the values related to a symbol d of the E11 base shown in Sheet Number 1-16-1 of C 7709-1 in Japanese Industrial Standards and is greater than the value related to a symbol d₁.

In this base 20, a brim-like contact part 27 having, at its lower surface, a contact surface S which is brought into contact with an end surface 411 of a cylindrical edge portion 42 related to a receiving space 43 in a socket 40 for discharge lamp, which will be described subsequently, is provided so as to extend along a plane perpendicular to the axial direction between the outer tube-holding part 21 and the feed member-supporting part 22.

In such a base 20, a distal end portion of the sealed part 13 of the discharge lamp 10 is inserted into the lamp-receiving portion in the outer tube-holding part 21 of the base body, one lead wire 261 connected to one external lead rod 161 is connected to the spiral feed member 24, and the other lead wire 262 connected to the other external lead rod 162 is connected to the dotted feed member 25, whereby a state that the spiral feed member 24 and dotted feed member 25 are electrically connected to the pair of the discharge electrodes of the arc tube 12, respectively is achieved. In this state, the base 20 is fixed to the discharge lamp 10 with an adhesive to install therein.

On the other hand, the socket 40 for discharge lamp according to the present invention is constructed by fixing, in a socket body 41, which is of cylinderical shape with a bottom forming a receiving space 43 opening to an upper side and composed of an insulating ceramic, a cylindrical and spiral receiving member 44 made of a metal along an internal peripheral surface of the socket body and, by fixing a contact piece 45 to an internal bottom surface of the socket body. The spiral receiving member 44 is that the spiral feed member 24 of the discharge lamp 10 is to be screwed, and the contact piece 45 is composed of a tongue-like plate material made of an elastic metal, for example, copper-nickel and extending upward from a base plate part fixed to a bottom surface of the socket body 41 in a form curved into a U shape. A contact is formed at its tip end portion. Reference numeral 42 indicates a cylindrical edge portion partitioning the opening of the receiving space. The end surface 411 of the cylindrical edge portion 42 is in a state arranged along a plane perpendicular to the axial direction.

In FIG. 2, reference numeral 46 designates one guiding part for external feed wire, in which an external feed wire connected to the spiral receiving member 44 is arranged, and reference numeral 47 indicates the other guiding part for external feed wire, in which an external feed wire connected to the contact piece 45 is arranged.

A discharge lamp device is shown in FIG. 3 in a state that the base part of the discharge lamp 10 received into the socket 40 for discharge lamp.

More specifically, in the discharge lamp device, the base part by the base 20 in the discharge lamp 10 is inserted from its distal end into the receiving space 43 of the socket 40 for discharge lamp, and the spiral feed member 24 is screwed into the spiral receiving member 44, and lastly rotated until the contact surface S directed downward in the brim-like contact part 27 of the base body comes into contact with the end surface 411 of the cylindrical edge portion 42 in the socket 40, thereby forming a fitted state. In this fitted state, the dotted feed member 25 at the tip end of the projected part 23 of the base 20 comes into contact with the contact portion of the contact piece 45, thereby forming a state that the contact piece 45 has been elastically deformed.

Accordingly, in this fitted state, the spiral feed member 24 is screwed into the spiral receiving member 44 of the socket 40, whereby the discharge lamp 10 is held by the socket 40. At the same time, the spiral feed member 24 comes into contact with the spiral receiving member 44, and the dotted feed member 25 comes into contact with the contact piece 45, whereby an electrically connected state in the socket 40 is achieved.

The discharge lamp device described above is connected to a discharge lamp lighting device having a lighting circuit for lighting the discharge lamp 10 at a lighting frequency of 50 Hz to 100 kHz to use it. This discharge lamp lighting device can apply ignition voltage of 2.0 to 3.5 KVrms for lighting the discharge lamp 10, or can apply pulse voltage of 3 to 5 KV in terms of maximum pulse height.

In the constitution described above, it is necessary in the base 20 making up the discharge lamp 10 that the shortest creeping clearance distance between the spiral feed member 24 and the dotted feed member 25 along the outer surface of the projected part 23 of the base body, i.e., distance (creeping distance between A and A′) between a position A of an inner peripheral edge at lower end of the spiral feed member 24 shown in FIG. 1 and a position A′ at an outer peripheral edge of the dotted feed member 25 opposed in the axial direction along the outer surface of the projected part 23 is at least 6.0 mm, with at least 7.4 mm being particularly preferred.

By satisfying such conditions in the base 20, high insulating property can be surely achieved between the spiral feed member 24 and the dotted feed member 25 even when the discharge lamp 10 is ignited at ignition voltage of 2.0 to 3.5 KVrms, or pulse voltage of 3 to 5 KV in terms of maximum pulse height, so that occurrence of discharge between them can be surely prevented.

The shortest creeping clearance distance in this base 20 is preferably at most 10.0 mm from the viewpoint of practical use. In this case, it is avoided that the base 20 becomes larger in vain.

In the socket 40 for discharge lamp, it is necessary that the shortest interterminal clearance distance between the spiral receiving member 44 and the contact piece 45, i.e., a distance (distance between B and B′) between a tip end position B′ of the contact piece 45 shown in FIG. 2 and a position B closest to the position B′ in the spiral receiving member 44 is at least 5.0 mm, with at least 5.6 mm being particularly preferred.

By satisfying such conditions in the socket 40, high insulating property can be surely achieved between the spiral receiving member 44 and the contact piece 45. As a result, occurrence of discharge between the spiral receiving member 44 and the contact piece 45 in the socket 40 can be surely prevented even when a discharge lamp used by being installed in the socket 40 is ignited at ignition voltage of 2.0 to 3.5 KVrms, or pulse voltage of 3 to 5 KV in terms of maximum pulse height.

The shortest interterminal clearance distance in this socket 40 is preferably at most 10.0 mm from the viewpoint of practical use. In this case, it is avoided that the socket 40 becomes larger in vain.

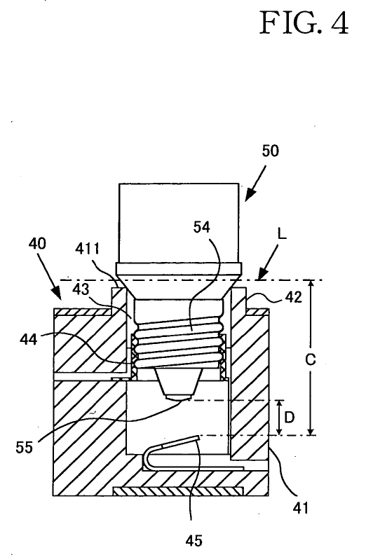

Further, in the socket 40 for discharge lamp, when the spiral receiving member 44 thereof is adapted to a base part according to the conditions of the E11 base as illustrated in FIG. 4, it is necessary that a distance C in the axial direction (vertical direction in FIG. 4) of the socket 40 between the level of the socket reference line L and the level of the tip end of the contact piece 45, which is located at the uppermost position thereof, is at least 19.6 mm.

The term “socket reference line L” as used herein means a reference line assumed about the socket, which conforms to the level of the reference line of the E11 base shown in Sheet Number 1-16-1 of C 7709-1 in Japanese Industrial Standards in a state that a base part according to the conditions of the E11 base has been received into the socket. Specifically, the line L is a line corresponding to a position at which a diameter on a plane perpendicular to the axial direction in the base body making up the base of the base part according to the conditions of the E11 base equals to a reference diameter value (13.49 mm).

The state that the base part according to the conditions of the E11 base has been fitted means a state that a tapered portion, whose outer diameter becomes greater as it goes upward, in a base body of a base 50 comes into contact with an inner edge of the cylindrical edge portion 42 related to the receiving space 43 of the socket 40 in the process that the base part according to the conditions of the E11 base is screwed and fitted into the socket 40 and rotated to go down as shown in, for example, FIG. 4, and so further rotation or progress of the base part is not allowed.

FIG. 4 illustrates a state that an ordinary base part according to the conditions of the E11 base has been fitted. In this example, the socket reference line L is located on the outside (position of the level away to upward) of the socket 40. In this state, a spiral feed member 54 of the base 50 is screwed into the spiral receiving member 44, while a dotted feed member 55 is in a state separated from the level of the tip end of the contact piece 45 by a distance D. The distance D in the socket 40 for discharge lamp is preset to a length of, for example, 3.8 mm.

The socket for discharge lamp according to the present invention is so constructed that the base part of the discharge lamp according to the present invention can be fitted. In this construction, it may be physically possible in some cases that an incandescent halogen lamp having a base part according to the conditions of the E11 base is also installed. However, in the socket for discharge lamp, the clearance distance C between the socket reference line L and the contact piece 45 is preset to at least 19.6 mm, whereby a dotted feed member of the incandescent halogen lamp having the base part according to the conditions of the E11 base does not approach the contact piece 45 and so a state separated with a sufficient distance is ensured, even when the incandescent halogen lamp is installed into the socket by mistake, so that high insulating property can be surely achieved between the incandescent halogen lamp and the contact of the socket. Accordingly, occurrence of discharge in the interior of the socket is surely prevented, and high safety is obtained even when high ignition voltage of 2.0 to 3.5 KVrms or high pulse voltage of 3 to 5 KV in terms of maximum pulse height for igniting the discharge lamp is applied to the incandescent halogen lamp through the feed members of the socket.

The clearance distance C between the socket reference line L and the contact piece 45 in the socket for discharge lamp is preferably at most 25.0 mm from the viewpoint of practical use. In this case, it is avoided that the socket becomes larger in vain.

According to the discharge lamp device of the present invention, both merits related to the discharge lamp described above and merits related to the socket for discharge lamp described above are obtained.

More specifically, the spiral feed member and dotted feed member in the base of the discharge lamp are in a state separated from each other with a creeping distance of sufficient size, so that high insulating property can be ensured between both feed members, and occurrence of discharge between them is surely prevented, and thus high safety is obtained.

Although it is possible to install the incandescent halogen lamp having the base part according to the conditions of the E11 base into the socket for discharge lamp, high insulating property can be ensured between the dotted feed member of the incandescent halogen lamp and the contact piece of the socket because a separated state with a sufficient distance is created between the dotted feed member and the contact piece in an installed state, so that occurrence of discharge between them is surely prevented, and thus high safety is obtained even when the incandescent halogen lamp is installed by mistake.

Although the embodiments of the present invention have been described above, the present invention is not limited to the above-described embodiments, and various changes or modifications may be added.

For example, the end surface 411 of the inner edge of the cylindrical edge portion 42 related to the receiving space 43 in the socket 40 for discharge lamp may be formed into a tapered shape, whose diameter becomes smaller as it goes downward. In this case, the angle of the tapered surface of the end surface 411 is preferably an angle adapted to an angle of the tapered portion of the base body of the base part received.

Specific experimental examples of the discharge lamp and socket for discharge lamp according to the present invention will hereinafter be described. However, the present invention is not limited thereby.

Discharge lamps (10) of lamp voltage of 70V and lamp power of 20 W were produced in accordance with the construction shown in FIG. 1. The lamps had respective structures with corresponding sizes of the shortest creeping clearance distances (distance between A and A′) between a spiral feed member (24) and a dotted feed member (25) in an outer surface of a projected part (23) of a base body in a base (20) as those shown in the following Table 1.

On the other hand, sockets (40) for discharge lamp were produced in accordance with the construction shown in FIG. 2. The sockets had respective structures with the shortest clearance distance (C) between a socket reference line (L) and a contact piece (45) in a state shown in FIG. 4 of 20.0 mm, and the shortest clearance distance (distance between B and B′) between a spiral receiving member (44) and the contact piece (45) as those shown in the following Table 2.

The thus-produced discharge lamps (10) and sockets (40) for discharge lamp were used to produce discharge lamp devices in accordance with the construction shown in FIG. 3, and the respective discharge lamps were lighted under ordinary-temperature and ordinary-humidity conditions of a temperature of 20±5° C. and a humidity of 40±10% using a lighting device having a lighting circuit of a lighting frequency of 60 Hz with ignition voltage varied.

With respect to the respective discharge lamps and sockets for discharge lamp, the lowest applied voltage values when discharge occurred were determined as dielectric withstand voltage values to rank them as “◯” where the dielectric withstand voltage value was sufficiently high, or “x” if not so. The results are shown in Tables 1 and 2.

TABLE 1

| The shortest creeping clearance distance | | |
|---|---|---|
| (distance between A and A′) between the | Dielectric withstand | |
| spiral feed member and the dotted feed | voltage value | Evalu- |
| member (mm) | (KVrms) | ation |
| 3.5 | 4.5 | X |
| 5.0 | 5.0 | X |
| 6.0 | 5.7 | ◯ |
| 7.4 | at least 6.0 | ◯ |

TABLE 2

| The shortest clearance distance | | |
|---|---|---|
| (distance between B and B′) between the | Dielectic withstand | |
| spiral receiving member and the contact | voltage value | Evalu- |
| piece (mm) | (KVrms) | ation |
| 3.5 | 3.0 | X |
| 5.0 | 5.3 | ◯ |
| 5.6 | at least 5.5 | ◯ |
| 7.5 | at least 5.5 | ◯ |

As apparent from the results shown in Tables 1 and 2, it is understood that according to the discharge lamp and socket for discharge lamp, which satisfy the conditions prescribed in the present invention, sufficiently high dielectric withstand voltage property is achieved, and high safety is obtained.

### EFFECTS OF THE INVENTION

According to the discharge lamp of the present invention, in the base making up the base part, the shortest creeping clearance distance between the spiral feed member and the dotted feed member along the outer surface of the projected part of the base body is defined to at least 6.0 mm, whereby high insulating property is achieved between the spiral feed member and the dotted feed member, so that discharge between them is surely prevented, and thus high safety is obtained.

According to the socket for discharge lamps of the present invention, the shortest clearance distance between the spiral receiving member, into which the spiral feed member in the base part of the discharge lamp installed is screwed, and the contact piece, with which the dotted feed member in the base part is brought into contact, is defined to at least 5.0 mm, whereby discharge between them is surely prevented, and thus high safety is obtained.

When a base part satisfying the conditions of the E11 base is received into the socket for discharge lamp, the shortest clearance distance between the socket reference line conforming to the base reference line of the base making up the base part and the contact piece is defined to be at least 19.6 mm in the socket for discharge lamp, whereby even when an incandescent halogen lamp having a base part according to the conditions of the E11 base is installed by mistake, a dotted feed member of the base part of the incandescent halogen lamp and the contact piece of the socket for discharge lamp are in a state separated from each other at a sufficient distance, so that it is surely prevented to apply high voltage for lighting a discharge lamp to the incandescent halogen lamp, and it is also surely prevented to cause discharge between the dotted feed member and the contact piece.

According to the discharge lamp device of the present invention, the discharge lamp device is constructed by the above-described discharge lamp and socket for discharge lamp, whereby the same operations and effects as described above can be surely achieved.

1. A discharge lamp constructed by housing an arc tube having a pair of discharge electrodes in an interior of an outer tube having a sealed part at a one-end thereof and attaching a base to the one-end of the outer tube, and lighted by ignition voltage of 2.0 to 3.5 KVrms or pulse voltage of 3 to 5 KV in terms of maximum pulse height, and
the base has an insulating base body having a feed member-supporting part and a projected part protruding and extending from a distal end of the feed member-supporting part, a spiral feed member provided on an outer periphery of the feed member-supporting part, electrically connected to one of the pair of the discharge electrodes and having a width of 10.4 to 11.0 mm, and a dotted feed member provided on a tip end of the projected part and electrically connected to the other of the pair of the discharge electrodes,
wherein, in the base, the shortest creeping clearance distance between the spiral feed member and the dotted feed member along an outer surface of the projected part of the base body is defined to at least 6.0 mm.

2. A socket for discharge lamp, into which a base part provided on a discharge lamp lighted by ignition voltage of 2.0 to 3.5 KVrms or pulse voltage of 3 to 5 KV in terms of maximum pulse height is received, and
a cylindrical and spiral receiving member, into which a spiral feed member in the base part of the discharge lamp is screwed, and a contact piece, with which a dotted feed member in the base part is brought into contact, are provided in an insulating socket body,
wherein the shortest clearance distance between the spiral receiving member and the contact piece is defined to at least 5.0 mm.

3. A socket for discharge lamp, into which a base part provided on a discharge lamp lighted by ignition voltage of 2.0 to 3.5 KVrms or pulse voltage of 3 to 5 KV in terms of maximum pulse height is received, and
a cylindrical and spiral receiving member, into which a spiral feed member in the base part of the discharge lamp is screwed, and a contact piece, with which a dotted feed member in the base part is brought into contact, are provided in an insulating socket body,
wherein, when a base part satisfying the conditions of the E11 base prescribed in Japanese Industrial Standards is received, the shortest clearance distance between a socket reference line conforming to a base reference line of a base making up the base part and the contact piece is defined to at least 19.6 mm.

4. A discharge lamp device comprising the discharge lamp according to claim 1 and a socket for discharge lamp, into which the base part provided on the discharge lamp is received, and
the socket for discharge lamp is constructed by providing a cylindrical and spiral receiving member, into which a spiral feed member in the base part of the discharge lamp is screwed, and a contact piece, with which a dotted feed member in the base part is brought into contact, in an insulating socket body,
wherein, in the socket for discharge lamp, the shortest clearance distance between the spiral receiving member and the contact piece is defined to at least 5.0 mm, and when a base part satisfying the conditions of the E11 base prescribed in Japanese Industrial Standards is received, the shortest clearance distance between a socket reference line conforming to a base reference line of a base making up the base part and the contact piece is defined to at least 19.6 mm.

5. A discharge lamp lighting device comprising a lighting circuit for lighting the discharge lamp according to claim 1 at a lighting frequency of 50 Hz to 100 kHz.
